(19) United States
(12) Patent Application Publication
(10) Pub. No.: US 2025/0313394 A1
(43) Pub. Date: Oct. 9, 2025

(54) COVER

(71) Applicant: Sumitomo Riko Company Limited, Aichi (JP)

(72) Inventor: Kazuki Itabashi, Aichi (JP)

(73) Assignee: Sumitomo Riko Company Limited, Aichi (JP)

(21) Appl. No.: 19/019,379

(22) Filed: Jan. 13, 2025

Related U.S. Application Data
(63) Continuation of application No. PCT/JP2024/013830, filed on Apr. 3, 2024.

(51) Int. Cl. B65D 81/02

(52) U.S. Cl. CPC B65D 81/02; B65D 2251/1058

(57) ABSTRACT

A cover includes a first cover body integrally having a first locking portion at a first end edge and a second cover body integrally having a second locking portion at a second end edge. By locking the first and second locking portions to each other, a target object is covered by the first and second cover bodies. The first cover body includes a pair of first slits extending in a direction intersecting the first end edge, starting from the first end edge; an opening locking portion integrally formed in an opening and closing area sandwiched between the pair of first slits; and a locked portion provided on a terminal side of the first slit. In a state where the opening and closing area is folded toward a terminal side of the first slit, when the opening locking portion is locked to the locked portion, the target object is partially exposed.

### CROSS-REFERENCE TO RELATED APPLICATION

This application is a continuation of PCT International Application No. PCT/JP2024/013830, filed on Apr. 3, 2024. The entire contents of the aforementioned application are hereby incorporated by reference herein.

### BACKGROUND

### Technical Field

The disclosure relates to a cover for covering a target object.

### Related Art

A cover for covering a target object is provided not only for protecting the target object, but also for the purpose of insulating sound generated from the target object to the outside and suppressing vibration generated from the target object.

For example, Patent Document 1 (Japanese Patent Application Laid-Open Publication No. S53-74401) discloses a device that covers a noise source such as industrial machinery to prevent noise. This noise prevention device prevents sound leakage to the outside by attaching a sound-absorbing material to the back surface of a waterproof or fireproof sheet to form a covering material, and fixing the covering material to necessary locations of the target object using Velcro tape (hook-and-loop fastener). In particular, this noise prevention device discloses an example in which the covering material is made partially openable and closable by providing a cut, and the opening and closing part is fixed with a hook-and-loop fastener in the normal state. In this example, when necessary, the opening and closing part may be opened to expose a part of the target object, allowing maintenance work or monitoring of instruments to be performed with the covering material fixed in place.

In the above example, depending on the exposed location or the shape of the opening and closing part, there may be cases where the opening and closing part returns to its original closed state if the hand is released after opening. In this case, the worker needs to hold the opening and closing part with one hand to prevent it from returning while performing work with only the other hand, resulting in poor workability.

Therefore, the disclosure provides a cover that may not only maintain the covered state of the target object appropriately but also allow inspection work at necessary locations to be performed with good workability while maintaining the covered state.

### SUMMARY

The disclosure includes a cover, the cover including
a first cover body formed of an elastomer and integrally having a first locking portion at a first end edge; and
a second cover body formed of elastomer and integrally having a second locking portion at a second end edge opposing the first end edge, the second locking portion being capable of locking to the first locking portion.

In a state where the first end edge and the second end edge are joined, by locking the first locking portion and the second locking portion to each other, a target object is covered by the first cover body and the second cover body.

The first cover body includes:
a pair of first slits extending in a direction intersecting the first end edge, starting from the first end edge;
an opening locking portion integrally formed in an opening and closing area sandwiched between the pair of first slits; and
a locked portion provided on a terminal side of the first slit.

In a state where the opening and closing area is folded along the pair of first slits toward a terminal side of the first slit, when the opening locking portion is locked to the locked portion, the target object is partially exposed.

### BRIEF DESCRIPTION OF DRAWINGS

FIG. 1 is a perspective view of the cover of Aspect 1 (the opening and closing area is in a closed state).

FIG. 2 is a left side view of the cover of Aspect 1 (the opening and closing area is in a closed state).

FIG. 3 is a plan view of the cover of Aspect 1 (the opening and closing area is in a closed state).

FIG. 4 is an exploded perspective view of the cover of Aspect 1 as viewed from above (the opening and closing area is in a closed state).

FIG. 5 is an exploded perspective view of the cover of Aspect 1 as viewed from below (the opening and closing area is in a closed state).

FIG. 6 is a cross-sectional view along line A-A of FIG. 2.

FIG. 7 is a cross-sectional view along line B-B of FIG. 2.

FIG. 8 is a cross-sectional view along line C-C of FIG. 2.

FIG. 9 is a cross-sectional view along line D-D of FIG. 2.

FIG. 10 is an illustrative diagram showing the state of the first locking portion and the second locking portion when removing the cover of Aspect 1.

FIG. 11 is a perspective view of the cover of Aspect 1 with the opening and closing area in an open state.

FIG. 12 is a left side view of the cover of Aspect 1 with the opening and closing area in an open state.

FIG. 13 is a cross-sectional view along line E-E of FIG. 12.

FIG. 14 is a perspective view of the cover of Aspect 2 (the opening and closing area is in a closed state).

FIG. 15 is a plan view of the cover of Aspect 2 (the opening and closing area is in a closed state).

FIG. 16 is a cross-sectional view along line F-F of FIG. 15.

FIG. 17 is a perspective view of the cover of Aspect 2 with the opening and closing area in an open state.

FIG. 18 is a left side view of the cover of Aspect 2 with the opening and closing area in an open state.

FIG. 19 is a cross-sectional view along line G-G of FIG. 18.

FIG. 20 is a perspective view of the cover of Aspect 3 (the opening and closing area is in a closed state).

FIG. 21 is a plan view of the cover of Aspect 3 (the opening and closing area is in a closed state).

FIG. 22 is a cross-sectional view along line H-H of FIG. 21.

FIG. 23 is a perspective view of the cover of Aspect 3 with the opening and closing area in an open state.

FIG. 24 is a left side view of the cover of Aspect 3 with the opening and closing area in an open state.

FIG. 25 is a cross-sectional view along line I-I of FIG. 24.

### DESCRIPTION OF EMBODIMENTS

In another aspect of the disclosure, in the above configuration, the opening locking portion is an opening locking piece protruding in a direction opposite to an abutting direction from the first end edge to the second end edge, and
the locked portion is a hole in which the opening locking piece is locked.

In another aspect of the disclosure, in the above configuration, the opening locking piece has a groove formed between the opening locking piece and the opening and closing area,
the hole is provided on an extension surface of the opening and closing area in a covered state of the target object by the opening and closing area, and
when the opening locking piece is inserted through the hole, the groove is locked to an edge portion of the hole.

In another aspect of the disclosure, in the above configuration, the opening and closing area has a stepped portion protruding on a surface side of the first cover body, and
the opening locking piece is provided on the stepped portion.

In another aspect of the disclosure, in the above configuration, the hole is formed in a size that allows the stepped portion to be inserted in a folded state of the opening and closing area.

In another aspect of the disclosure, in the above configuration, the pair of first slits are formed sandwiching the first locking portion, and the first locking portion, which is integral with the opening and closing area, also serves as the opening locking portion, and
the locked portion is a locking hole into which the first locking portion is inserted and locked in a state where the opening and closing area is folded towards a terminal side of the first slit.

In another aspect of the disclosure, in the above configuration, a first sound-absorbing material formed of foam resin is configured on an inner surface of the first cover body, and
in the first sound-absorbing material, a pair of second slits extending in a direction intersecting with the first end edge are formed on an inner side of the opening and closing area, starting from an inner side end edge positioned on the first end edge side, and an inner side opening and closing area of the first sound-absorbing material sandwiched between the pair of second slits is folded along the pair of second slits toward a terminal side of the second slit together with the opening and closing area to partially expose the target object, while
in a covered state of the target object by the opening and closing area, the pair of second slits are covered by the opening and closing area.

In another aspect of the disclosure, in the above configuration, the inner side opening and closing area is fixed to the opening and closing area.

Hereinafter, the embodiments of the disclosure are described with reference to the drawings.

### Aspect 1

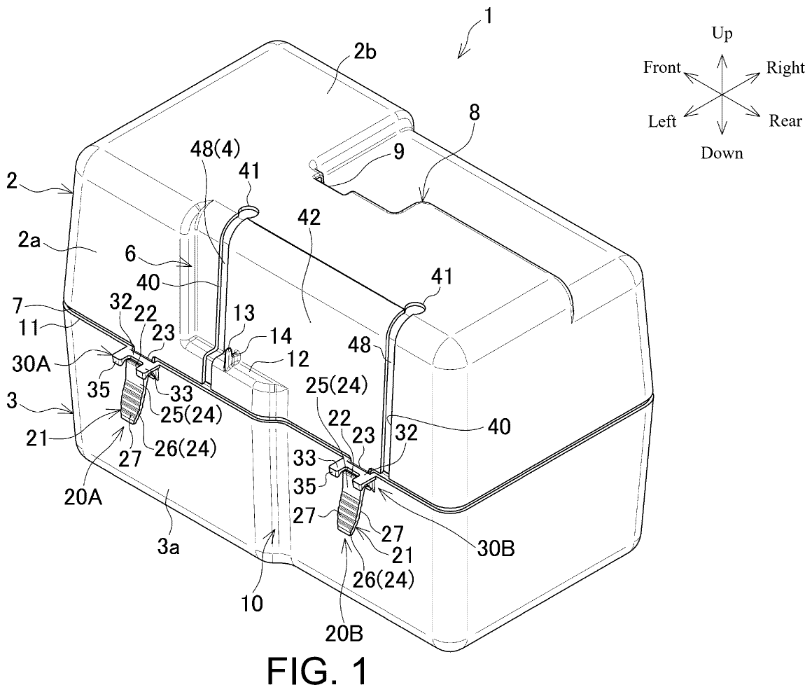

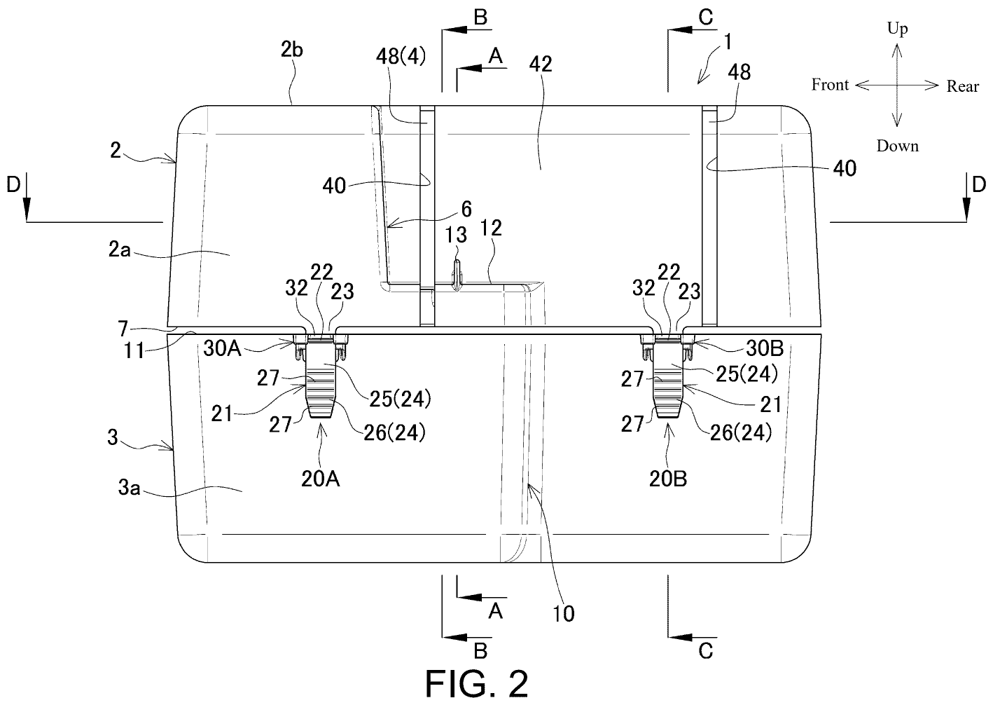

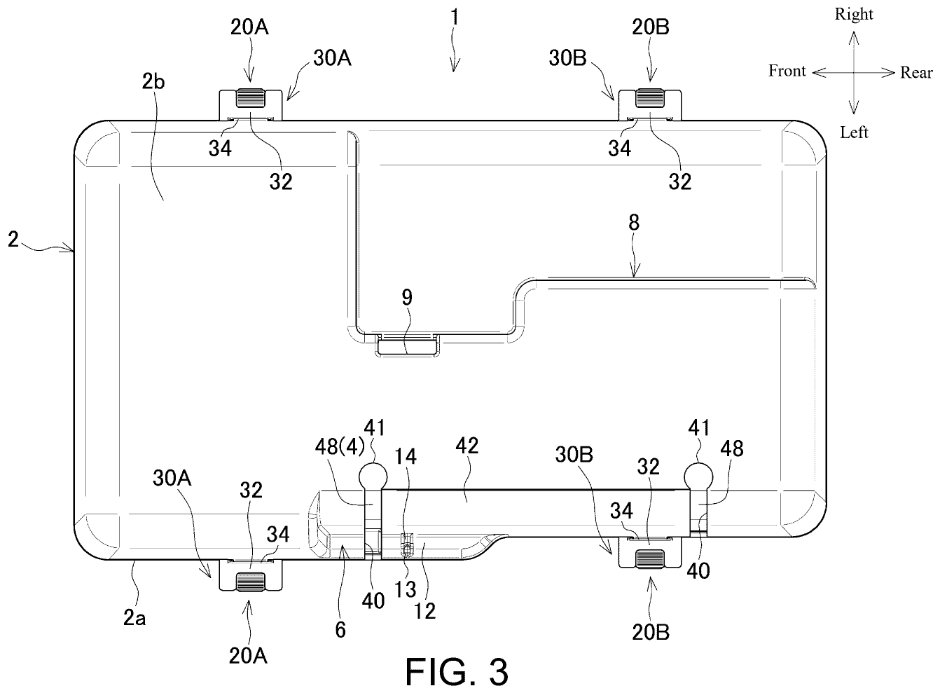

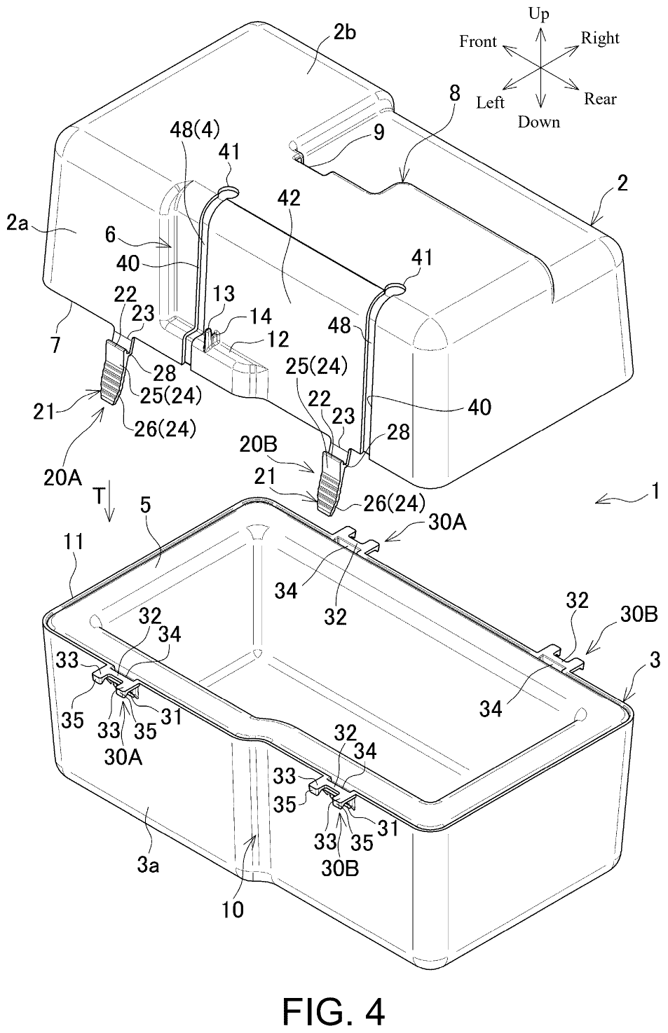

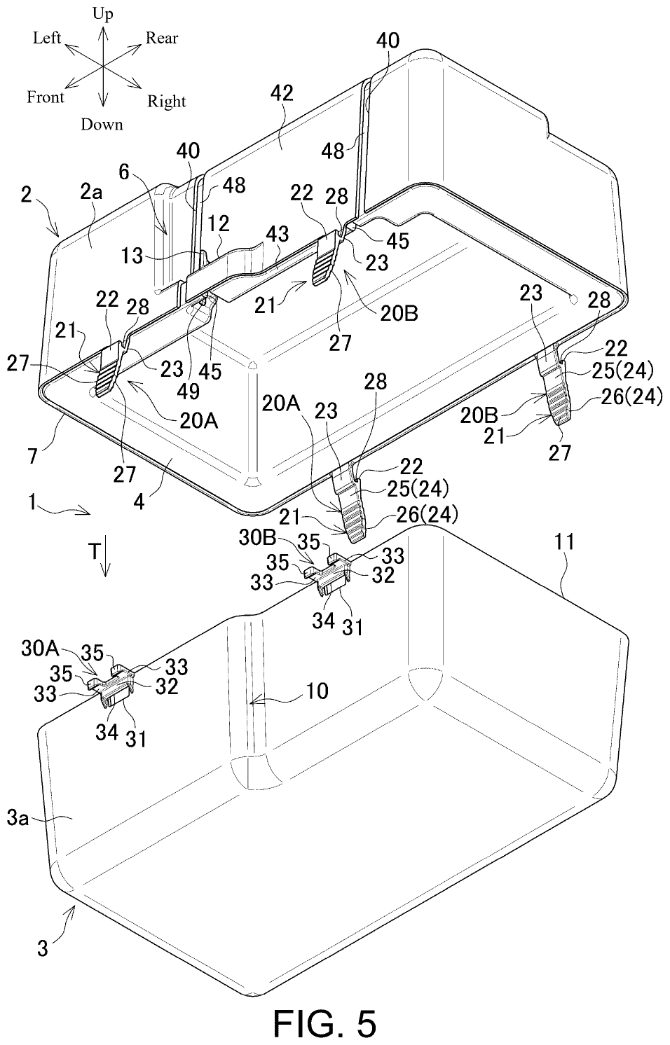

FIG. 1 is a perspective view showing an example of a cover 1. FIG. 2 is a left side view of the cover 1. FIG. 3 is a plan view of the cover 1. FIG. 4 is an exploded perspective view of the cover 1 as viewed from above. FIG. 5 is an exploded perspective view of the cover 1 as viewed from below. In all cases, the opening and closing area 42 to be described later is in a closed state. For convenience, the upper side (first cover body 2 side) in FIG. 2 is defined as the top and the lower side (second cover body 3 side) as the bottom; the left side in FIG. 2 is defined as the front and the right side as the rear; and the side surface appearing in FIG. 2 is defined as the left and the opposite side surface as the right, thus defining each direction.

The cover 1 has an overall shape of a rectangular parallelepiped. Both the front and rear ends of the rectangular parallelepiped are closed. The cover 1 is divided into two parts, upper and lower, substantially at the center in the up and down direction, and is formed by joining a box-shaped first cover body 2 and a second cover body 3, also box-shaped, facing each other and above and below.

The first cover body 2 is formed of an elastomer. The hardness of the elastomer is, for example, Shore A hardness 90 to 95. A first sound-absorbing material 4 is integrally fixed to the entire inner surface of the first cover body 2. The first sound-absorbing material 4 is formed of urethane foam. Urethane foam is an example of the foam resin of the disclosure.

The second cover body 3 is also formed of an elastomer. The hardness of the elastomer is, for example, Shore A hardness 90 to 95. A second sound-absorbing material 5 formed of urethane foam is also fixed to the entire inner surface of the second cover body 3.

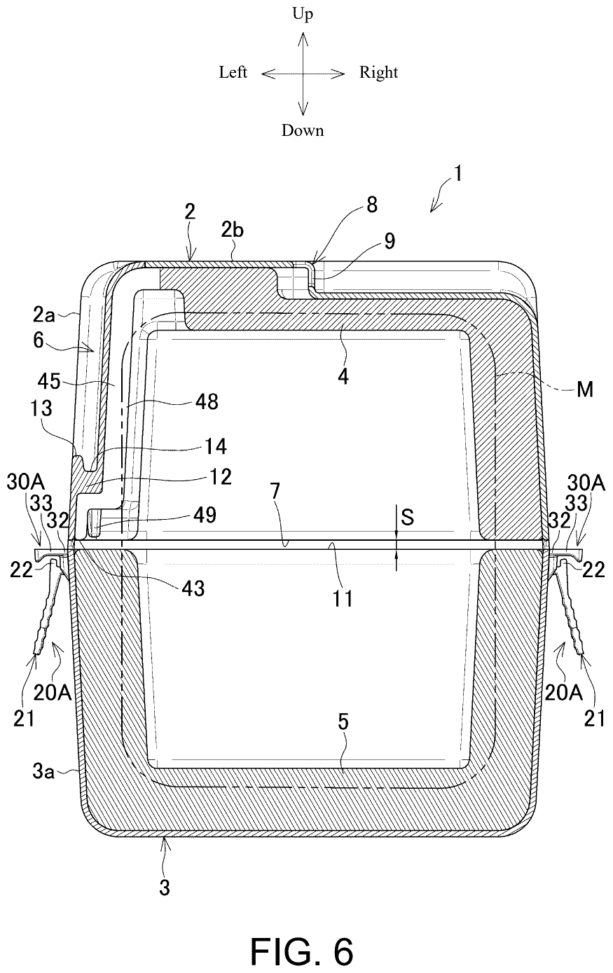

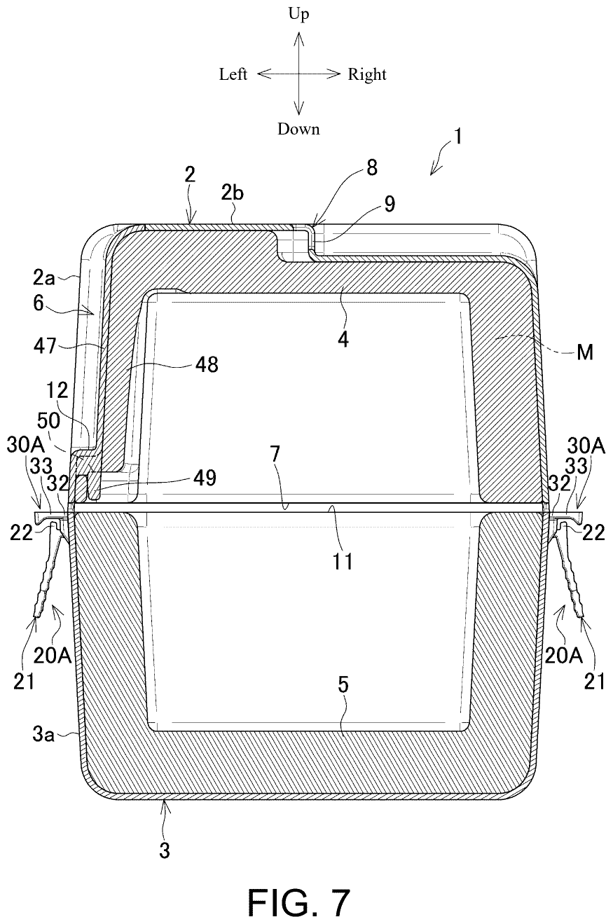

The cover 1 is used to cover the target object M shown by the two-dot chain line in FIG. 6 and FIG. 7 to protect the target object M and provide sound insulation from the target object M to the outside. The target object M is, for example, a motor. In the state where the target object M is covered, the first sound-absorbing material 4 and the second sound-absorbing material 5 elastically deform to hold the target object M.

A first stepped portion 6 is formed on the left side surface 2a of the first cover body 2. The first stepped portion 6 is recessed from the surface towards the back surface, positioning the central portion and rear portion of the left side surface 2a more inward (to the right side) than the front portion. The first stepped portion 6 extends downward from the upper end of the left side surface 2a, then bends towards the rear side, extends parallel to the lower end edge 7 of the first cover body 2, and further bends downward to reach the lower end edge 7.

An upper surface stepped portion 8 is provided on the upper surface 2b of the first cover body 2. The upper surface stepped portion 8 is also recessed from the surface towards the back surface, positioning the right rear portion of the upper surface 2b more inward (downward) than the front portion and left rear portion. The upper surface stepped portion 8 extends from the right end of the upper surface 2b towards the left side, then bends towards the rear side and extends in the front and rear direction. However, the rear portion of the upper surface stepped portion 8 extending in the front and rear direction protrudes more to the right side than the front portion. A hole 9 opening to the right side is formed in the front portion of the upper surface stepped portion 8. The hole 9 exposes the first sound-absorbing material 4. The upper surface stepped portion 8 is an example of the stepped portion of the disclosure. The hole 9 is an example of the locked portion of the disclosure.

A second stepped portion 10 is formed on the left side surface 3a of the second cover body 3. The second stepped portion 10 positions the rear portion of the left side surface 3a more inward (to the right side) than the front portion. The second stepped portion 10 extends downward as an extension from the terminal end of the first stepped portion 6 that reaches the lower end edge 7.

As shown in FIG. 4 and FIG. 5, in the first cover body 2, front and rear pairs of first locking portions 20A and 20B are integrally provided on the left and right sides of the lower end edge 7, respectively. The front and rear positions of the first locking portions 20A and 20B are the same on both left and right sides, but on the left side surface 2a, the first locking portion 20B on the rear side is positioned more towards the rear side than the first stepped portion 6. Thus, the first locking portion 20B is located closer to the right than the first locking portion 20A on the front side in the left and right direction. The lower end edge 7 is an example of the first end edge of the disclosure.

In the second cover body 3, front and rear pairs of second locking portions 30A and 30B are integrally provided on the left and right sides of the upper end edge 11, respectively. The front and rear positions of the second locking portions 30A and 30B are the same on both left and right sides, but on the left side surface 3a, the second locking portion 30B on the rear side is positioned more towards the rear side than the second stepped portion 10, and is located more towards the right side in the left and right direction than the front second locking portion 30A. The upper end edge 11 is an example of the second end edge of the disclosure.

Thus, in response to abutting the lower end edge 7 of the first cover body 2 against the upper end edge 11 of the second cover body 3, each of the first locking portions 20A and 20B faces each of the second locking portions 30A and 30B. The first cover body 2 and the second cover body 3 are joined by locking the opposing first locking portions 20A and 20B to the second locking portions 30A and 30B.

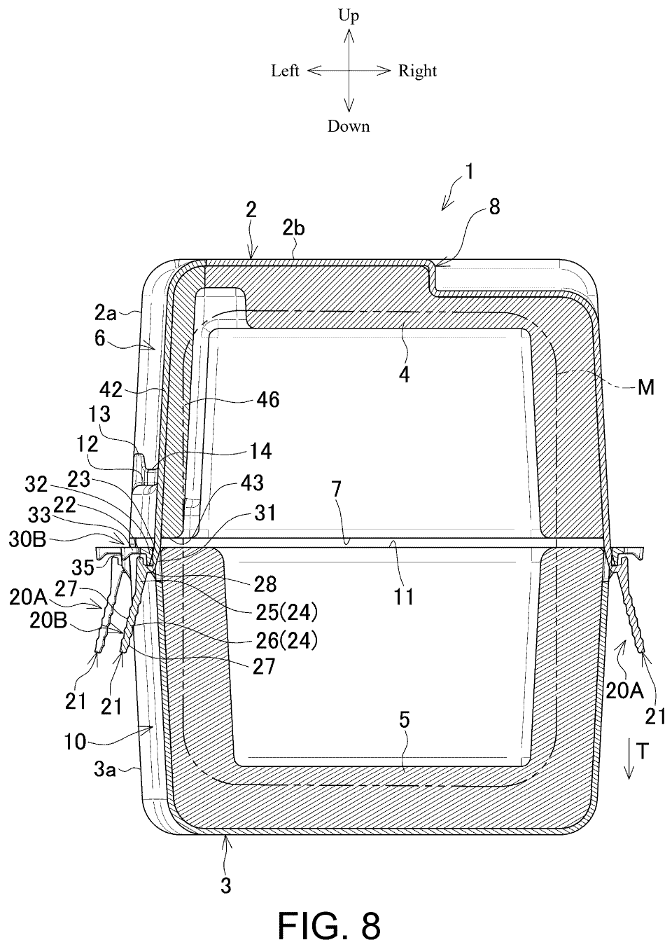

The details of the first locking portions 20A and 20B are described. The first locking portions 20A and 20B have the same structure and include a protruding piece 21 and a return piece 22. The protruding piece 21 is a strip-shaped plate protruding from the lower end edge 7 of the first cover body 2 in the abutting direction towards the second locking portions 30A and 30B. The arrow T shown in FIG. 4, FIG. 5, and FIG. 8 indicates the abutting direction.

The protruding piece 21 includes a base end portion 23 and a tip end portion 24. The base end portion 23 protrudes from the lower end edge 7 in the abutting direction T, with the tip end bent towards the left and right outer sides.

The tip end portion 24 protrudes in the abutting direction T from the bent end portion of the base end portion 23. The tip end portion 24 includes a locking plate 25 and an insertion plate 26. The locking plate 25 is continuous with the bent end portion of the base end portion 23. The insertion plate 26 is continuous with the locking plate 25. However, as shown in FIG. 6 and FIG. 7, the insertion plate 26 is inclined at a predetermined angle towards the left and right outer sides, intersecting with the abutting direction T relative to the locking plate 25. Thus, the insertion plate 26 protrudes in an inclined direction that separates from the first cover body 2 towards the left and right outer sides as it approaches the abutting direction T side.

A plurality of projecting strips 27, 27 . . . are formed on two surfaces of the insertion plate 26 in the thickness direction. The projecting strips 27 extend in the width direction of the insertion plate 26 and are formed at equal intervals in the protruding direction of the insertion plate 26.

The return piece 22 protrudes from the outer surface of the protruding piece 21 between the base end portion 23 and the locking plate 25, in a direction opposite to the abutting direction T. Due to the formation of this return piece 22, a locking groove 28 is formed between the base end portion 23 of the protruding piece 21 and the return piece 22, penetrating in the width direction of the protruding piece 21. The locking groove 28 opens in a direction opposite to the abutting direction T.

The second locking portions 30A and 30B have the same structure and include a notch 31, a bridge portion 32, and projection portions 33 and 33. The notch 31 is formed by cutting out from the upper end edge 11 of the second cover body 3 towards the abutting direction T. The bridge portion 32 extends in a strip-like manner along the upper end edge 11, straddling the notch 31 on the outer side of the second cover body 3. Consequently, an insertion hole 34 is formed on the inner side of the bridge portion 32, communicating with the notch 31 and extending along the upper end edge 11. The length of this insertion hole 34 in the direction along the upper end edge 11 is slightly larger than the width of the protruding piece 21 of the first locking portions 20A and 20B.

The projection portions 33 and 33 protrude outward from the outer surfaces on two sides of the bridge portion 32 that sandwich the notch 31. At the protruding end portion of each projection portion 33, a head portion 35 is formed, protruding in the abutting direction T.

On the left side surface 2a of the first cover body 2, a pair of first slits 40 and 40 are formed on the front and rear of the first locking portion 20B on the rear side. The first slits 40 and 40 are continuously formed starting from the lower end edge 7, extending upward along the left side surface 2a, and reaching the circular-shaped terminals 41 and 41 formed on the upper surface 2b. The first slit 40 on the front side crosses the intermediate part 12 of the first stepped portion 6 extending in the front and rear direction. Consequently, an opening and closing area 42 is formed on the first cover body 2, sandwiched between the first slits 40 and 40. The first locking portion 20B is located in the rear portion of the opening and closing area 42 in the front and rear direction.

In the opening and closing area 42, an opening locking piece 13 is formed on the upper surface of the intermediate part 12. The opening locking piece 13 is a plate-like body extending in the left and right direction, with the left side protruding upward in an L-shape when viewed from the rear. Consequently, a groove 14 is formed between the left side of the opening locking piece 13 and the opening and closing area 42. The opening locking piece 13 is an example of the opening locking portion of the disclosure.

On the upper surface 2b, the hole 9 of the upper surface stepped portion 8 is positioned on the extension surface of the opening and closing area 42 and also on the extension surface of the opening locking piece 13. On the inner side of the opening and closing area 42, parts that may require maintenance, such as the terminal portion of the target object M, are located.

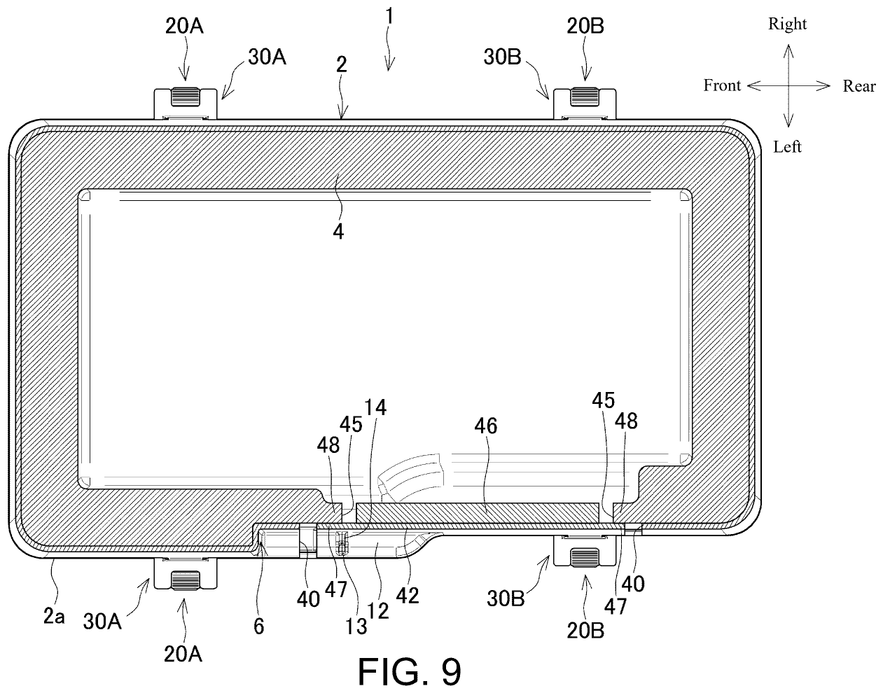

The first sound-absorbing material 4 has an inner side end edge 43 extending along the inner side of the lower end edge 7 of the first cover body 2. In the first sound-absorbing material 4 on the inner side of the left side surface 2a, a pair of second slits 45 and 45 are formed on the front and rear of the first locking portion 20B on the rear side. As shown in FIG. 9, the second slits 45 and 45 are positioned between the first slits 40 and 40 in the front and rear direction. The second slits 45 and 45 are continuously formed starting from the inner side end edge 43, extending upward, and reaching the terminal on the inner side of the upper surface 2b. In the left and right direction, the terminals of the second slits 45 and 45 are in substantially the same position as the terminals 41 and 41 of the first slits 40 and 40. Consequently, an inner side opening and closing area 46 is formed on the first sound-absorbing material 4, sandwiched between the second slits 45 and 45 and integrated with the opening and closing area 42.

The opening and closing area 42 may be lifted upward from the lower end edge 7 and folded towards the terminals 41 and 41 of the first slits 40 and 40 together with the inner side opening and closing area 46. In response to this action, the opening and closing area 42 and the inner side opening and closing area 46 enter an open state where a part of the cover 1 opens. When the opening and closing area 42 and the inner side opening and closing area 46 are returned to their original positions, they enter a closed state where the opening is closed.

Due to the front and rear interval of the first slits 40 and 40 being larger than the front and rear interval of the second slits 45 and 45, outer overhanging portions 47 and 47 are formed on the opening and closing area 42, protruding further outward in the front and rear direction than the inner side opening and closing area 46. Conversely, inner overhanging portions 48 and 48 are formed on the first sound-absorbing material 4 on the front and rear of the second slits 45 and 45, protruding further inward in the front and rear direction than the opening and closing area 42. In the closed state of the opening and closing area 42, the outer overhanging portions 47 and 47 overlap the outer sides of the inner overhanging portions 48 and 48, covering the outer sides of the second slits 45 and 45.

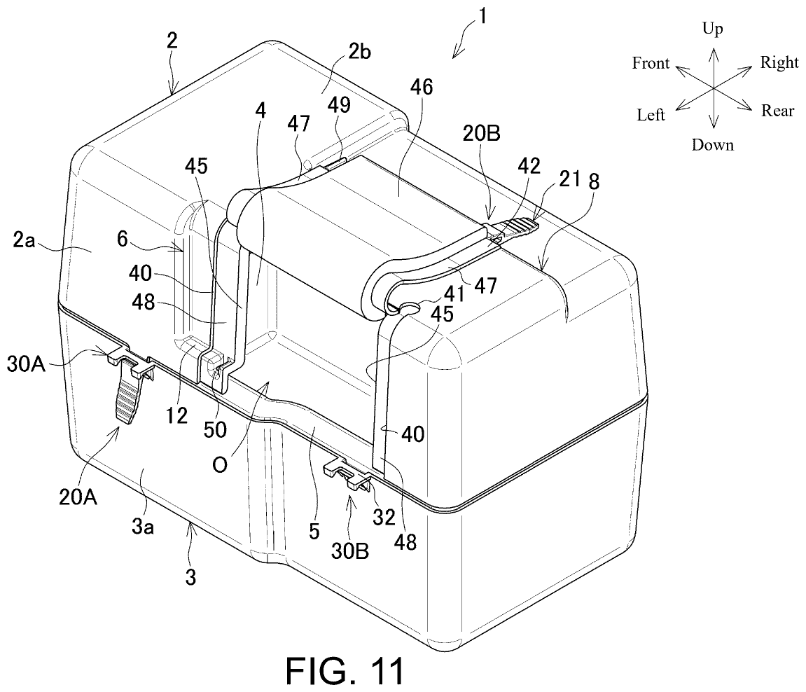

As shown in FIG. 6, FIG. 7, and FIG. 11, a locking claw 49 is formed downward on the lower end inner side of the outer overhanging portion 47 on the front side that forms the intermediate part 12 of the first stepped portion 6. A locking hole 50 is formed on the bottom surface of the recessed portion formed on the lower end outer side of the inner overhanging portion 48 on the front side, into which the locking claw 49 is inserted and locked in the closed state of the opening and closing area 42. The closed state of the opening and closing area 42 is maintained by the locking between the locking claw 49 and the locking hole 50. The intermediate part 12 is an example of a stepped portion protruding on the surface side of the first cover of the disclosure.

When using the cover 1 configured as described above, first, half of the target object M is covered with either the first cover body 2 or the second cover body 3. In this state, while covering the remaining half of the target object M with the other of the first cover body 2 and the second cover body 3, the opposing first locking portions 20A and 20B and second locking portions 30A and 30B are locked to each other. Specifically, the insertion plates 26 of each protruding piece 21 of the first locking portions 20A and 20B are inserted into the insertion holes 34 of the bridge portions 32 of the second locking portions 30A and 30B, and then pulled in the abutting direction T until the return pieces 22 pass through the bridge portions 32. After the return pieces 22 have passed through the bridge portions 32, the bridge portions 32 are elastically locked into the locking grooves 28. As a result, as shown in FIG. 8, the first locking portions 20A and 20B are locked to the second locking portions 30A and 30B in a manner that prevents them from coming off, and the target object M is covered by the cover 1.

As the bridge portions 32 are elastically locked into the locking grooves 28, the first locking portions 20A and 20B are prevented from coming off, thereby reducing the risk of accidental disengagement due to external impacts or other forces. In particular, since the return pieces 22 are positioned on the outer side of the bridge portions 32, the bridge portions 32 are more unlikely to come off the locking grooves 28.

It is noted that in the covered state of the target object M, a gap S (FIG. 6 and FIG. 7) is formed between the first cover body 2 and the second cover body 3. Thus, cables or other components connected to the target object M may be drawn out through the gap S.

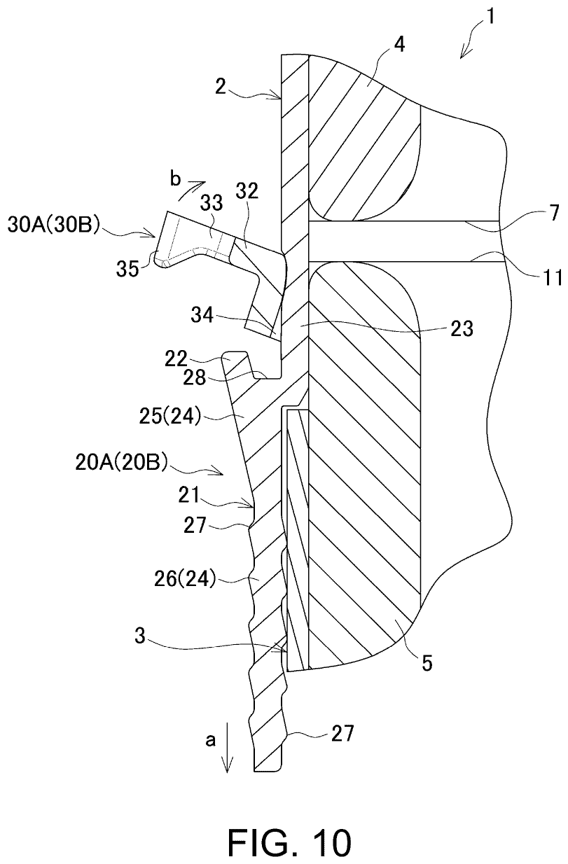

On the other hand, to remove the cover 1 from the target object M, the insertion plates 26 of each protruding piece 21 of the first locking portions 20A and 20B are grasped and pulled towards the second cover body 3 side, as indicated by arrow a in FIG. 10. This allows the locking grooves 28 to be separated from the bridge portions 32, releasing the locking. At this time, the projection portions 33 and 33 of the second locking portions 30A and 30B are tilted towards the first cover body 2 side via the head portions 35 and 35, as indicated by arrow b. As a result, the bridge portions 32 also move elastically towards the first cover body 2 side along with the projection portions 33 and 33. Thus, the bridge portions 32 may be easily separated from the locking grooves 28.

Once the locking grooves 28 are separated from the bridge portions 32, the base end portions 23 along with the return pieces 22 are passed through the insertion holes 34 from the inner side of the bridge portions 32 and removed from the second locking portions 30A and 30B. Then, the tip end portions 24 are passed through the insertion holes 34 from the inner side of the bridge portions 32 and removed from the second locking portions 30A and 30B. By releasing the locking between each of the first locking portions 20A and 20B and each of the second locking portions 30A and 30B in this manner, the first cover body 2 and the second cover body 3 may be removed from the target object M.

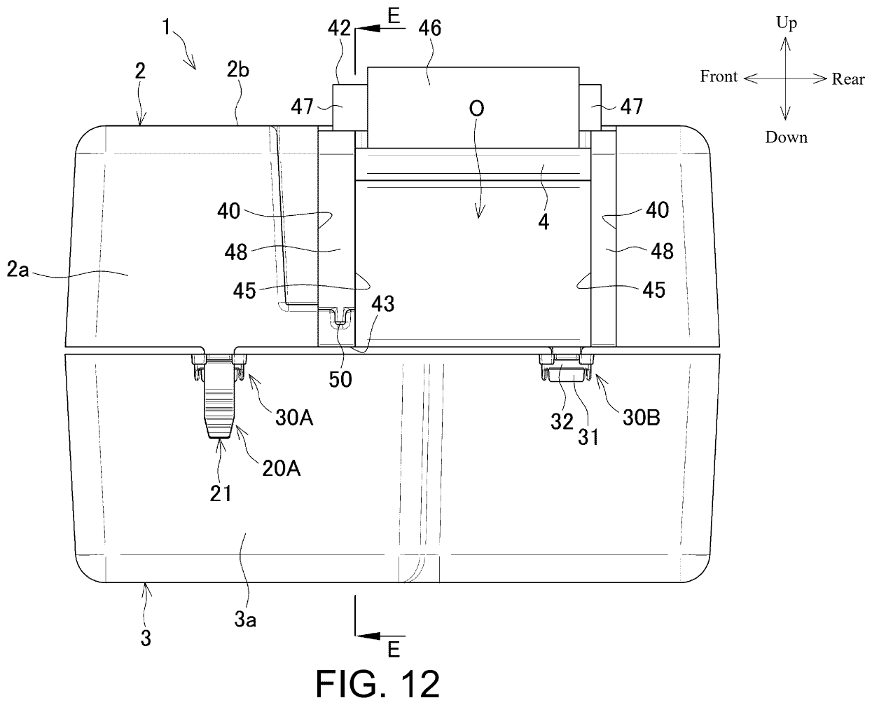

In the case of performing maintenance or inspection of the terminal portion or other parts of the target object M while the cover 1 remains attached, first, the protruding piece 21 of the first locking portion 20B connected to the opening and closing area 42 is removed from the second locking portion 30B. Next, as shown in FIG. 11 and FIG. 12, while still grasping the protruding piece 21, the opening and closing area 42 is folded together with the inner side opening and closing area 46 towards the upper surface 2b side. At this time, due to the elasticity of the first sound-absorbing material 4, the locking claw 49 of the opening and closing area 42 is removed from the locking holes 50 without resistance, so there is no hindrance to folding the opening and closing area 42.

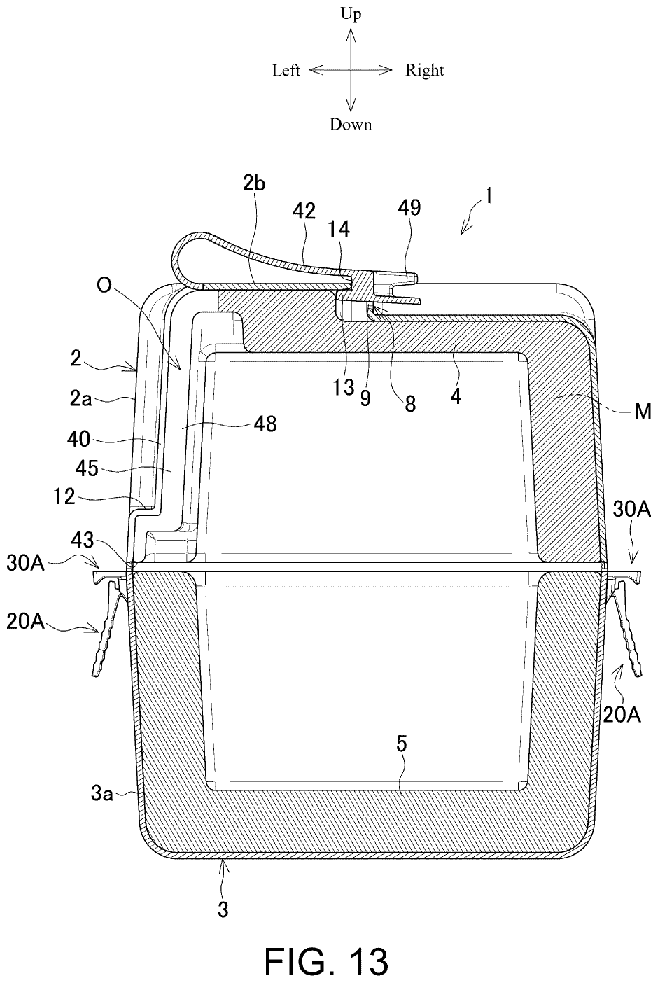

In this state where the opening and closing area 42 and the inner side opening and closing area 46 are folded, the opening locking piece 13 is inserted through the hole 9 in the upper surface stepped portion 8. As a result, as shown in FIG. 13, the groove 14 is locked to the upper side edge portion of the hole 9, maintaining the opening and closing area 42 and the inner side opening and closing area 46 in the open state. Consequently, an opening O is partially formed on the left side surface 2a, exposing the terminal portion and other parts. Thus, the worker may perform maintenance, inspection, or other work on the target object M through the opening O without having to hold the opening and closing area 42 and the inner side opening and closing area 46 by hand.

When the work is completed, the protruding piece 21 of the opening and closing area 42 is grasped and pulled to the right side. As a result, the opening locking piece 13 is separated from the hole 9, releasing the locking, allowing the opening and closing area 42 and the inner side opening and closing area 46 to be rotated back to the left side surface 2a and returned to the closed state. Next, the locking claw 49 is locked to the locking hole 50, and the protruding piece 21 is inserted into the insertion hole 34 of the second locking portion 30B to prevent it from coming out, thereby maintaining the closed state.

In this manner, the cover 1 of the aforementioned Aspect includes a first cover body 2 formed of an elastomer and integrally having first locking portions 20A and 20B on a lower end edge 7, and a second cover body 3 formed of an elastomer and integrally having second locking portions 30A and 30B on an upper end edge 11 facing the lower end edge 7, which are capable of locking to the first locking portions 20A and 20B.

The cover 1, in a state where the lower end edge 7 and the upper end edge 11 are joined together, becomes capable of covering the target object M with the first cover body 2 and the second cover body 3 by locking the first locking portions 20A and 20B to the second locking portions 30A and 30B, respectively.

The first cover body 2 includes a pair of first slits 40 and 40 extending in a direction intersecting with the lower end edge 7 starting from the lower end edge 7, an opening locking piece 13 integrally formed on the opening and closing area 42 sandwiched between the pair of first slits 40 and 40, and a hole 9 provided on the terminal side of the first slits 40 and 40.

Then, in a state where the opening and closing area 42 is folded along the pair of first slits 40 and 40 towards the terminal ends 41 and 41 of the first slits 40 and 40, by locking the opening locking piece 13 to the hole 9, the target object M may be partially exposed.

According to this configuration, even when formed of an elastomer, the covered state of the target object M may be suitably maintained with a simple structure. Thus, a highly reliable cover 1 may be provided.

On the other hand, by locking the opening locking piece 13 to the hole 9 in a state where the opening and closing area 42 is folded, the open state may be maintained without the worker having to hold the opening and closing area 42 by hand, allowing the target object M to be exposed while the cover 1 is attached. Thus, inspection work of necessary locations may be performed with good workability while maintaining the covered state.

The opening locking portion is an opening locking piece 13 protruding in a direction opposite to the abutting direction T from the lower end edge 7 to the upper end edge 11, and the locked portion is a hole 9 through which the opening locking piece 13 may be inserted.

Thus, with a simple structure of inserting and locking the opening locking piece 13 to the hole 9, the open state of the opening and closing area 42 may be maintained.

The opening locking piece 13 has a groove 14 formed between the opening locking piece 13 and the opening and closing area 42, the hole 9 is provided on an extension surface of the opening and closing area 42 in the covered state of the target object M by the opening and closing area 42, and when the opening locking piece 13 is inserted into the hole 9, the groove 14 is locked to the edge portion of the hole 9.

Thus, the locked state between the opening locking piece 13 and the hole 9 is effectively maintained, making it less likely for the opening and closing area 42 in the open state to unexpectedly return to the closed state.

The opening and closing area 42 has an intermediate part 12 of the first stepped portion 6 protruding on the surface side of the first cover body 2, and the opening locking piece 13 is provided on the intermediate part 12.

Thus, by utilizing the intermediate part 12, the opening locking piece 13 may be provided at a position where it may be easily locked to the hole 9.

A first sound-absorbing material 4 formed of foam resin is configured on the inner surface of the first cover body 2, in the first sound-absorbing material 4, on the inner side of the opening and closing area 42, a pair of second slits 45 and 45 are formed extending in a direction intersecting with the lower end edge 7, starting from an inner side end edge 43 parallel to the lower end edge 7. The inner side opening and closing area 46 of the first sound-absorbing material 4 sandwiched between the pair of second slits 45 and 45 may be folded towards the terminal side of the second slits 45 and 45 along the pair of second slits 45 and 45 together with the opening and closing area 42, thereby partially exposing the target object M.

Then, in the covered state of the target object M by the opening and closing area 42, the pair of second slits 45 and 45 are covered by the opening and closing area 42.

Thus, even with the first sound-absorbing material 4 provided on the inner side of the first cover body 2, the target object M may be exposed by opening the inner side opening and closing area 46. Further, in the closed state, the second slits 45 and 45 are covered by the opening and closing area 42, so even with the second slits 45 and 45 provided in the first sound-absorbing material 4, the covered state of the target object M may be maintained, preventing the intrusion of foreign objects from the outside.

The inner side opening and closing area 46 is fixed to the opening and closing area 42.

Thus, the inner side opening and closing area 46 automatically follows the opening and closing action of the opening and closing area 42, and the opening and closing action of the opening and closing area 42 may be performed without hindrance even with the presence of the inner side opening and closing area 46.

The second locking portions 30A and 30B includes a notch 31 formed from the upper end edge 11 in the abutting direction T, and a bridge portion 32 formed along the upper end edge 11 on the outer surface side of the second cover body 3 so as to straddle the notch 31, and an insertion hole 34 communicating with the notch 31 is formed on the inner side of the bridge portion 32.

Then, by inserting the protruding piece 21 through the insertion hole 34 and locking the return piece 22 to the bridge portion 32, the first locking portions 20A and 20B are locked to the second locking portions 30A and 30B.

Thus, the locking and unlocking operation between the first locking portions 20A and 20B and the second locking portions 30A and 30B may be easily performed.

The protruding piece 21 includes a base end portion 23 protruding from the upper end edge 11, and a tip end portion 24 protruding in the abutting direction T from the protruding end portion of the base end portion 23, the return piece 22 is formed between the base end portion 23 and the tip end portion 24, and a locking groove 28 opening in a direction opposite to the abutting direction T is formed between the base end portion 23 and the tip end portion 24.

Then, by inserting the tip end portion 24 and the base end portion 23 through the insertion hole 34, locking the locking groove 28 to the bridge portion 32, and positioning the return piece 22 on the outer side of the bridge portion 32, the first locking portions 20A and 20B are locked to the second locking portions 30A and 30B in a slip-off prevention state.

Thus, the reliability of the locked state between the first locking portions 20A and 20B and the second locking portions 30A and 30B may be improved.

Projecting strips 27 are formed on both the outer surface and inner surface of the insertion plate 26.

Thus, the projecting strips 27 serve as anti-slip features when grasping the insertion plate 26, making it easier to operate.

The bridge portion 32 is positioned at a location spaced outwardly from the outer surface of the second cover body 3.

Thus, it becomes easier to insert the protruding piece 21 of the first locking portions 20A and 20B into the inner side of the bridge portion 32.

Projection portions 33 protruding outwardly are provided on the outer surface of the bridge portion 32.

Thus, when removing the cover 1, the bridge portion 32 may be elastically deformed in a direction away from the locking groove 28 by utilizing the projection portions 33, making it easier to perform the unlocking operation between the first locking portions 20A and 20B and the second locking portions 30A and 30B.

A first sound-absorbing material 4 and a second sound-absorbing material 5, formed of urethane foam, are positioned on the inner surfaces of the first cover body 2 and the second cover body 3, respectively.

Thus, the sound insulation effect is enhanced when covering the target object M.

Next, a modification example of Aspect 1 is described.

The shape of the opening locking piece is not limited to the aforementioned Aspect 1. As long as it may be locked in the hole of the upper surface stepped portion, its width may be increased or it may be formed into a curved hook shape.

The shape of the hole may also be modified to match the shape of the opening locking piece, such as reducing its width to form a slit-like shape, or changing it from a rectangular hole to a round hole or other shapes.

The upper surface stepped portion where the hole is formed may also be made inclined or curved. In the opening and closing area of the aforementioned Aspect 1, the first locking portion is formed to be positioned at the rear portion in the front and rear direction, but the first locking portion may be formed to be positioned at the center of the opening and closing area in the front and rear direction. The first locking portion may also be absent from the opening and closing area.

Next, another Aspect of the disclosure is described. However, the same reference numerals are assigned to the same components as in Aspect 1, and redundant descriptions are omitted.

### Aspect 2

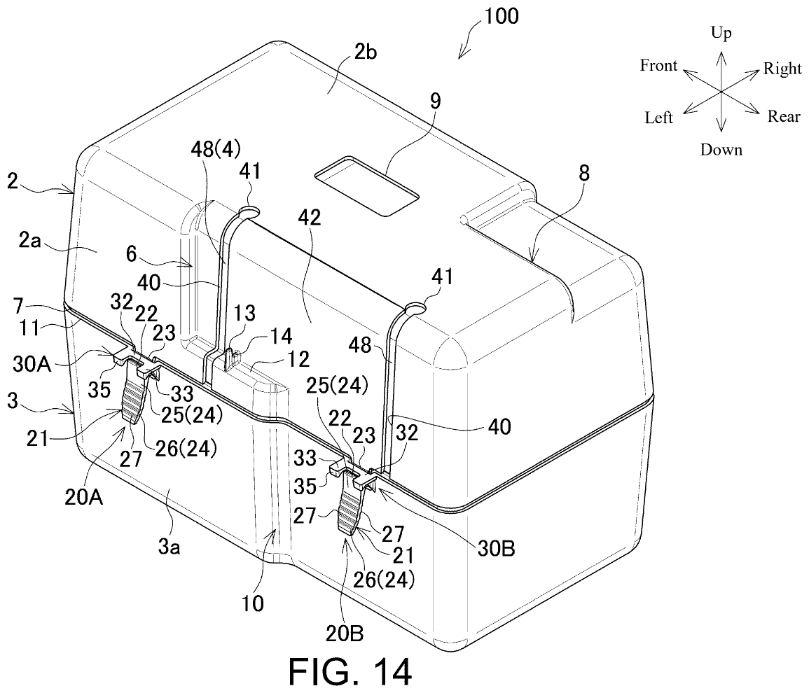

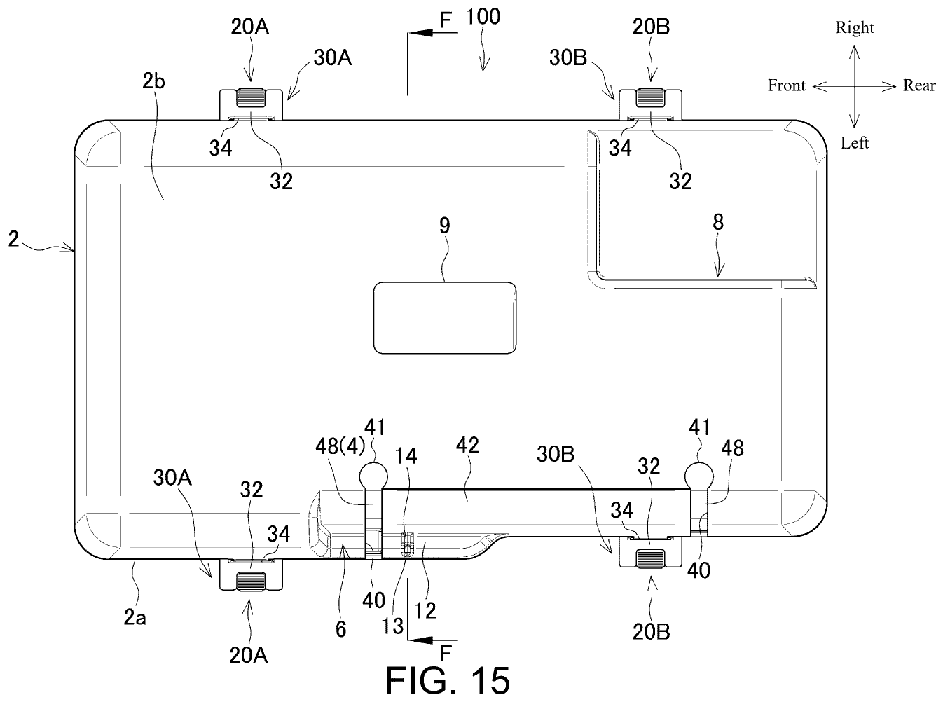

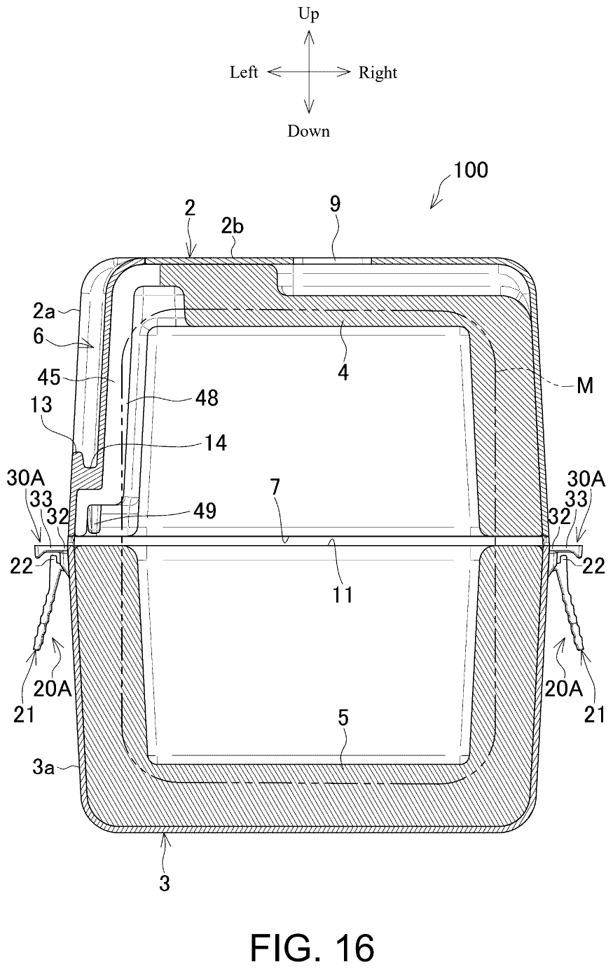

FIG. 14 is a perspective view of the cover 100 of Aspect 2, FIG. 15 is a plan view of the cover 100, and FIG. 16 is a cross-sectional view along line F-F in FIG. 15. In all figures, the opening and closing area is in a closed state.

In the cover 100, compared to the cover 1 of Aspect 1, the front end of the upper surface stepped portion 8 is positioned more towards the rear, resulting in a smaller area of the recessed portion. Consequently, in the state where the opening and closing area 42 is folded, the upper surface stepped portion 8 is not positioned below the opening locking piece 13.

The hole 9 is formed on the upper surface 2b more towards the front side than the upper surface stepped portion 8, rather than on the upper surface stepped portion 8 itself. The hole 9 has a rectangular shape when viewed from above and is sized to allow insertion of a part of the opening and closing area 42, including the intermediate part 12 of the first stepped portion 6 where the opening locking piece 13 is formed.

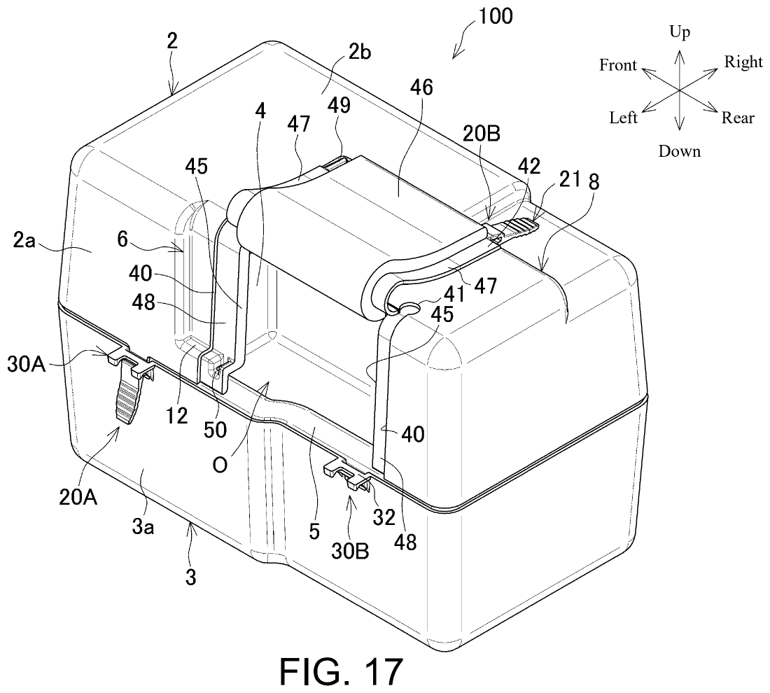

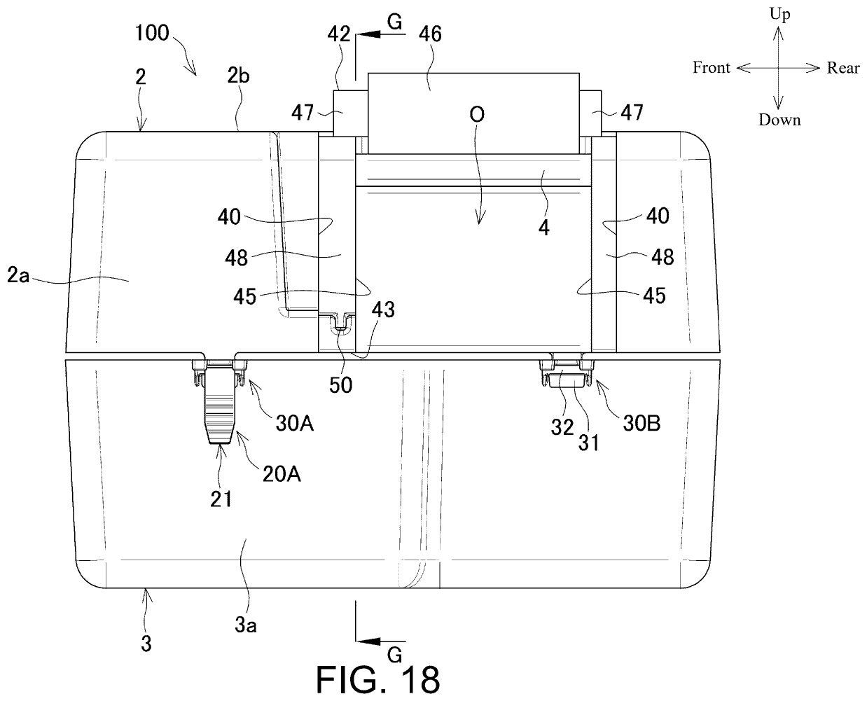

Thus, in the case of performing maintenance or inspection of the terminal portion or other parts of the target object M while the cover 100 remains attached, first, the protruding piece 21 of the first locking portion 20B connected to the opening and closing area 42 is removed from the second locking portion 30B. Next, as shown in FIG. 17 and FIG. 18, while still grasping the protruding piece 21, the opening and closing area 42 is folded together with the inner side opening and closing area 46 towards the upper surface 2b side.

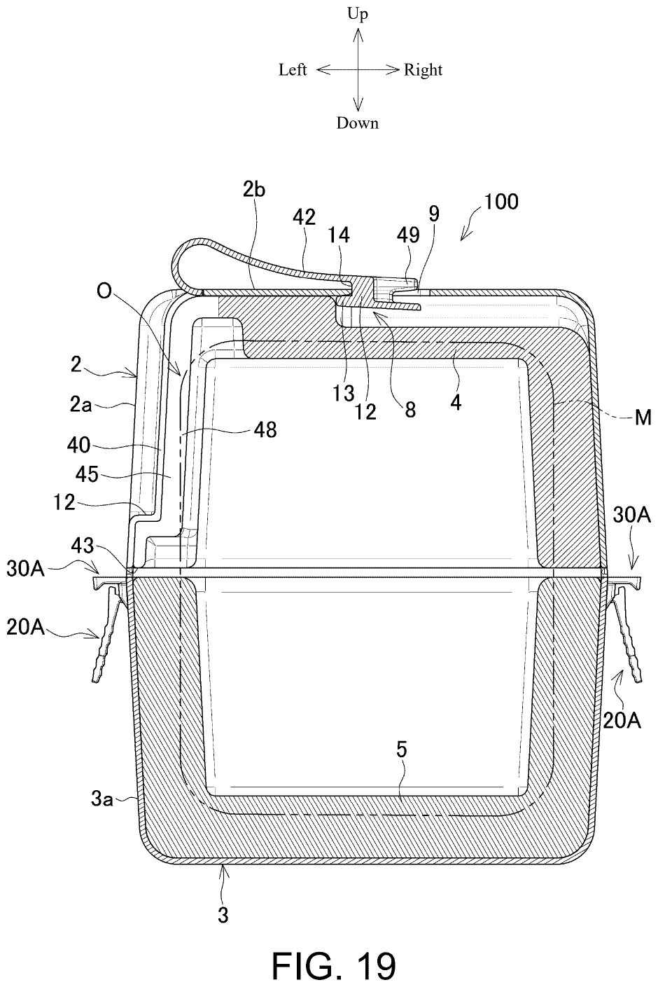

In this state where the opening and closing area 42 and the inner side opening and closing area 46 are folded, the intermediate part 12 of the first stepped portion 6 in the opening and closing area 42 is inserted into the hole 9 of the upper surface stepped portion 8, and the opening locking piece 13 is locked to the left side edge portion of the hole 9. At this time, the first locking portion 20B is placed in the recessed portion of the upper surface 2b, extending beyond the upper surface stepped portion 8. As a result, as shown in FIG. 19, the groove 14 is locked to the upper side edge portion of the hole 9, maintaining the opening and closing area 42 and the inner side opening and closing area 46 in the open state. Consequently, an opening O is partially formed on the left side surface 2a, exposing the terminal portion and other parts. Thus, the worker may perform maintenance, inspection, or other work on the target object M through the opening O without having to hold the opening and closing area 42 and the inner side opening and closing area 46 by hand.

When the work is completed, the locking claw 49 of the opening and closing area 42 or the protruding piece 21 of the first locking portion 20B is grasped and pulled to the right. As a result, the opening locking piece 13 is separated from the hole 9, releasing the locking, allowing the opening and closing area 42 and the inner side opening and closing area 46 to be rotated back to the left side surface 2a and returned to the closed state. Next, the locking claw 49 is locked to the locking hole 50, and the protruding piece 21 is inserted into the insertion hole 34 of the second locking portion 30B to prevent it from coming out, thereby maintaining the closed state.

In this manner, even in the cover 100 of Aspect 2, with a simple structure, the covered state of the target object M may be suitably maintained even when formed of an elastomer. Thus, a highly reliable cover 100 may be provided.

On the other hand, by locking the opening locking piece 13 to the hole 9 in a state where the opening and closing area 42 is folded, the open state may be maintained without the worker having to hold the opening and closing area 42 by hand, allowing the target object M to be exposed while the cover 100 is attached. Thus, inspection work of necessary locations may be performed with good workability while maintaining the covered state.

In particular, the hole 9 is formed in a size that allows the insertion of the intermediate part 12 in the folded state of the opening and closing area 42.

Thus, even though the intermediate part 12, which is a stepped portion, is formed on the opening and closing area 42, the opening and closing area 42 may be folded along the upper surface 2b of the first cover body 2, making it less likely for the opening and closing area 42 to interfere with work in the open state.

Next, a modification example of Aspect 2 is described.

The shape of the opening locking piece is not limited to the aforementioned Aspect 2. As long as it may be locked to the edge portion of the hole, its width may be increased or it may be formed into a curved hook shape.

The shape of the hole may also be appropriately changed to match the shape of the stepped portion of the opening and closing area. It may be made into an oval shape or other shapes instead of a rectangular shape.

In the opening and closing area of the aforementioned Aspect 2, the first locking portion is formed to be positioned at the rear portion in the front and rear direction, but the first locking portion may be formed to be positioned at the center of the opening and closing area in the front and rear direction. The first locking portion may also be absent from the opening and closing area.

### Aspect 3

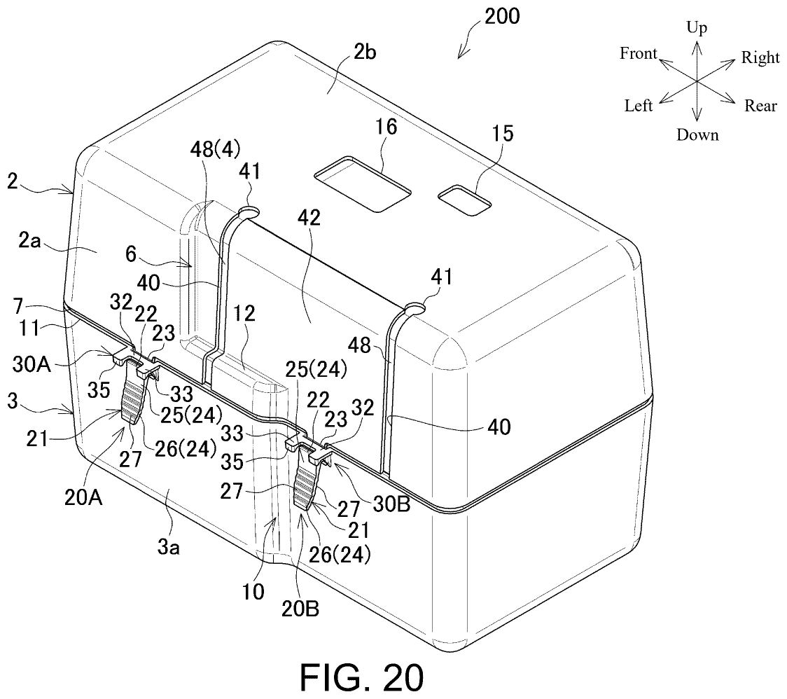

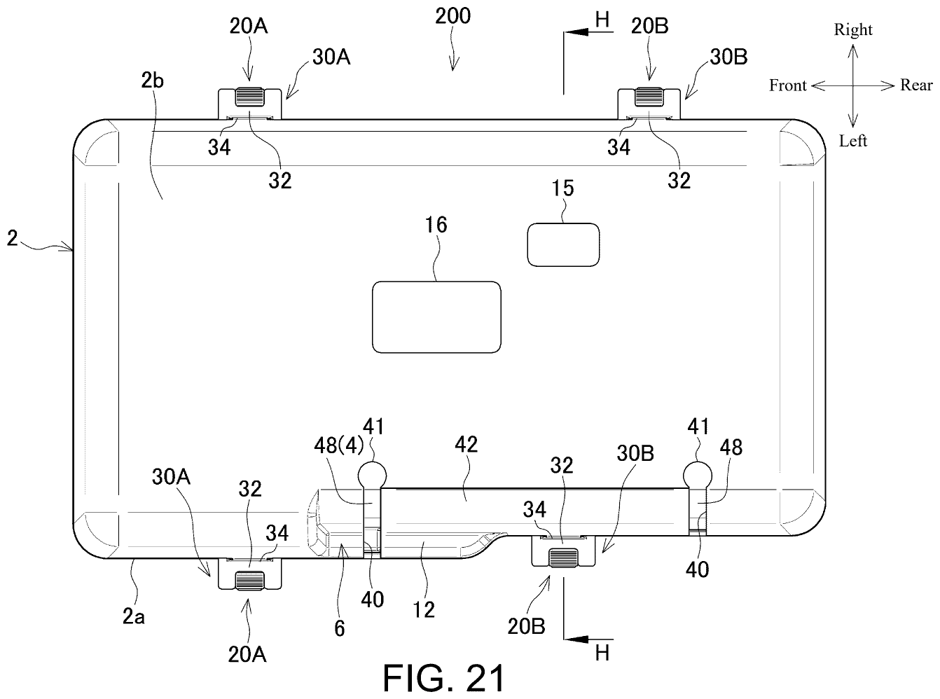

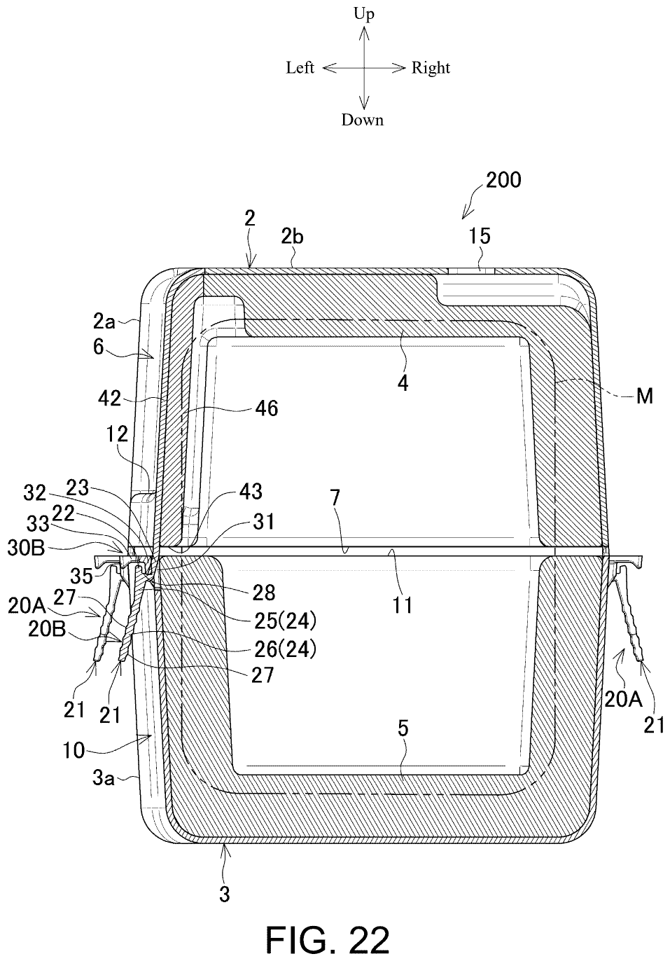

FIG. 20 is a perspective view of the cover 200 of Aspect 3, FIG. 21 is a plan view of the cover 200, and FIG. 22 is a cross-sectional view along the H-H line in FIG. 21. In all figures, the opening and closing area is in a closed state.

In the cover 200, no upper surface stepped portion is provided on the upper surface 2b, and the first slits 40 and 40 are provided at positions sandwiching the first locking portion 20B on the rear side of the left side surface 2a. Thus, the first locking portion 20B is integrally formed at substantially the center in the front and rear direction of the opening and closing area 42.

On the upper surface 2b, a locking hole 15 is formed at the position where the first locking portion 20B is placed when the opening and closing area 42 is in the folded state. The locking hole 15 is rectangular in plan view and allows the protruding piece 21 of the first locking portion 20B to be inserted when the opening and closing area 42 is in the folded state. In this inserted state, the return piece 22 of the protruding piece 21 may be locked to the edge portion of the locking hole 15. The locking hole 15 is an example of the locked portion of the disclosure.

On the front side of the locking hole 15, a release hole 16 is formed. The release hole 16 is rectangular in plan view and is sized to allow insertion of a part of the opening and closing area 42, including the intermediate part 12 of the first stepped portion 6, when the opening and closing area 42 is in a folded state. It should be noted that in this Aspect 3, no opening locking piece is provided on the intermediate part 12.

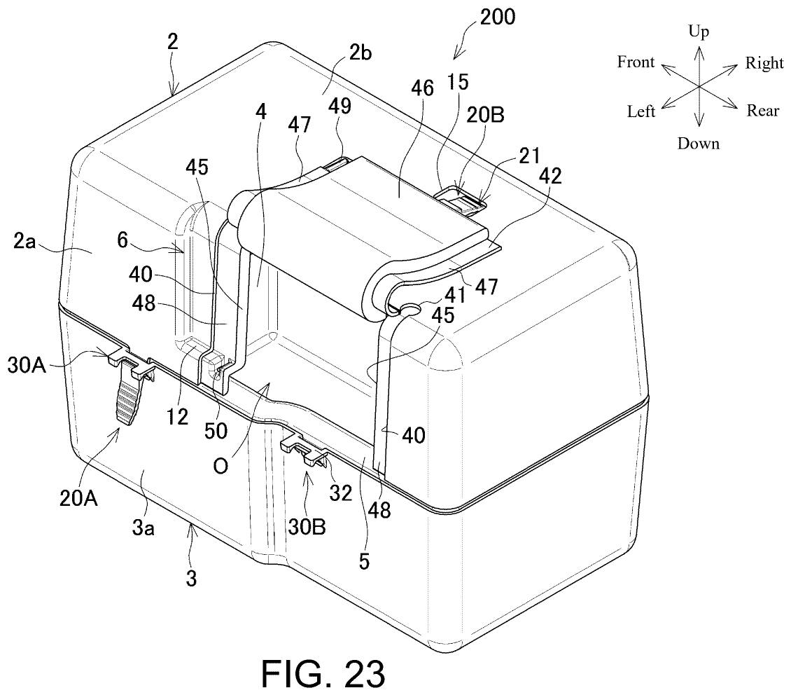

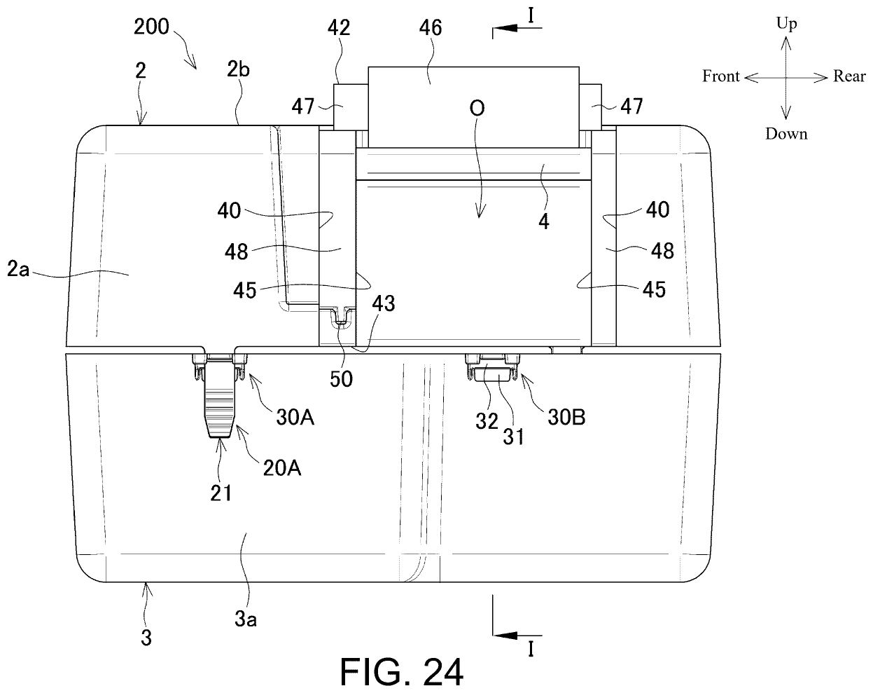

Thus, in the case of performing maintenance or inspection of the terminal portion or other parts of the target object M while the cover 200 remains attached, first, the protruding piece 21 of the first locking portion 20B connected to the opening and closing area 42 is removed from the second locking portion 30B. Next, as shown in FIG. 23 and FIG. 24, while still grasping the protruding piece 21, the opening and closing area 42 is folded together with the inner side opening and closing area 46 towards the upper surface 2b side.

In this state where the opening and closing area 42 and the inner side opening and closing area 46 are folded, the intermediate part 12 of the first stepped portion 6 in the opening and closing area 42 is inserted into the release hole 16 on the upper surface 2b. Simultaneously, the protruding piece 21 of the first locking portion 20B is inserted into the locking hole 15, and the return piece 22 is locked to the edge portion. At this time, since the intermediate part 12 is inserted into the release hole 16 and the folded end portion of the opening and closing area 42 is pressed against the upper surface 2b, there is no hindrance to the insertion of the protruding piece 21.

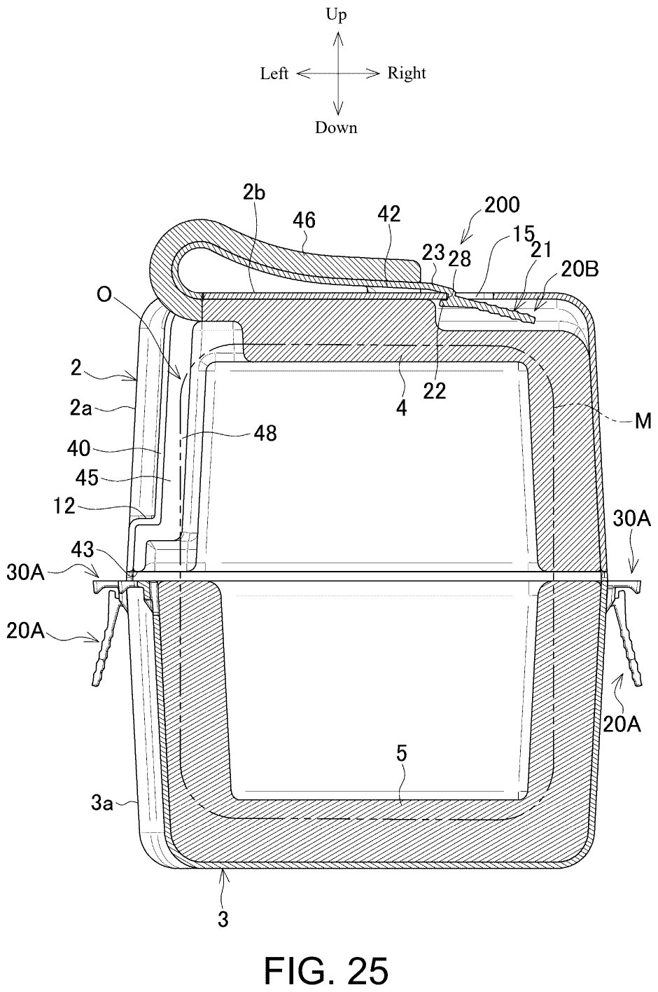

As a result, as shown in FIG. 25, the locking groove 28 of the protruding piece 21 is locked to the left side edge portion of the locking hole 15, and the opening and closing area 42 and the inner side opening and closing area 46 are maintained in an open state. Consequently, an opening O is partially formed on the left side surface 2a, exposing the terminal portion and other parts. Thus, the worker may perform maintenance, inspection, or other work on the target object M through the opening O without having to hold the opening and closing area 42 and the inner side opening and closing area 46 by hand.

When the work is completed, the protruding piece 21 of the first locking portion 20B is grasped and pulled to the right side. As a result, the return piece 22 separates from the locking hole 15, releasing the locking, allowing the protruding piece 21 to be removed from the locking hole 15. The opening and closing area 42 and the inner side opening and closing area 46 may be rotated back to the left side surface 2a, returning them to the closed state. Next, the locking claw 49 is locked to the locking hole 50, and the protruding piece 21 is inserted into the insertion hole 34 of the second locking portion 30B to prevent it from coming out, thereby maintaining the closed state.

In this manner, even in the cover 200 of Aspect 3, with a simple structure, the covered state of the target object M may be suitably maintained even when formed of an elastomer. Thus, a highly reliable cover 200 may be provided.

On the other hand, by locking the first locking portion 20B to the locking hole 15 in the state where the opening and closing area 42 is folded, the open state may be maintained without the worker having to hold the opening and closing area 42 by hand, allowing the target object M to be exposed while the cover 200 remains attached. Thus, inspection work of necessary locations may be performed with good workability while maintaining the covered state.

In particular, here, a pair of first slits 40 and 40 are formed sandwiching the first locking portion 20B, and the first locking portion 20B, which is integral with the opening and closing area 42, also serves as the opening locking portion. Then, the locked portion is configured as the locking hole 15 into which the first locking portion 20B may be inserted and locked in the state where the opening and closing area 42 is folded towards the terminal side of the first slit 40.

Thus, this results in a rational configuration where the first locking portion 20B also serves as the opening locking portion.

The following describes modification examples of Aspect 3.

In the aforementioned Aspect 3, the first locking portion integral with the opening and closing area is provided substantially at the center in the front and rear direction of the opening and closing area, but the first locking portion may be positioned closer to the rear portion of the opening and closing area. The first locking portion may lock a part other than the return piece into the locking hole. Multiple first locking portions may be present on the opening and closing area. In this case, locking holes may be provided for each first locking portion, or multiple first locking portions may be inserted and locked into a single locking hole.

The locking hole is not limited to a rectangular shape in plan view. The shape of the locking hole in plan view may be appropriately modified as long as the first locking portion may be inserted and locked into it.

In the aforementioned Aspect 3, a release hole is provided for inserting the stepped portion of the opening and closing area, but the shape of the release hole may be appropriately modified to match the shape of the stepped portion. The release hole may be omitted.

The following describes modification examples common to each Aspect of the disclosure.

The opening and closing area may be appropriately modified to match the position and size of the portion of the target object to be exposed. Thus, the terminal end of the first slit may be positioned more towards the right on the upper surface of the first cover body compared to the aforementioned Aspect. Conversely, the terminal end of the first slit may be on the right side surface instead of the upper surface of the first cover body. The first slit may be curved.

There may be multiple opening and closing areas. They may be present on surfaces other than the left side surface of the first cover body.

The angle at which the first slit extends is not limited to perpendicular to the first end edge, but may be in any intersecting direction. Thus, the opening and closing area is not limited to a rectangular shape.

The inner side opening and closing area does not necessarily need to be fixed to the opening and closing area. In this case, a locking portion that mutually locks with the opening and closing area may be provided so that the inner side opening and closing area may follow the opening and closing of the opening and closing area.

The shapes of the first and second stepped portions of the first cover body may be appropriately modified. For example, the first stepped portion may consist only of a part extending in the up and down direction without a bent shape. However, the first and second stepped portions may be omitted.

The second slit provided in the first sound-absorbing material may also be appropriately modified to match the first slit. The second slit may be formed at the same interval as the first slit.

The configuration of the locking claw and the locking hole may be provided on opposite sides of each other, or another locking structure may be adopted as long as it may position the opening and closing area in the closed state. This locking structure may be provided at the rear portion instead of the front portion of the opening and closing area, or it may be provided at both the front and rear sides. This locking structure may be omitted.

In the aforementioned Aspects, two first locking portions are provided on the left and right sides of the first end edge of the first cover body, but the number of first locking portions is not limited to two, and three or more may be provided.

On the side opposite to the formation side of the opening and closing area, there may be only one first locking portion. The second locking portion of the second cover body may also be appropriately modified to match the number and position of the first locking portion.

The shape of the first locking portion itself may also be appropriately modified. For example, the shape and number of projecting strips provided on the insertion plate are not limited to the aforementioned Aspect. The projecting strips may be provided on only one side of the insertion plate instead of both the front and back surfaces. The projecting strips may be omitted.

In the second locking portion, the shape and number of projection portions are not limited to the aforementioned Aspect. The projection portions may have a shape where their upper ends are connected to each other. The projection portions may be omitted.

The overall shape of the cover is not limited to a rectangular parallelepiped. The overall shape of the cover may be, for example, cylindrical, and may be appropriately modified to match the shape of the target object.

The first and second sound-absorbing materials are not limited to urethane foam, and may be formed of other foam resins. If the desired sound insulation performance may be obtained with the first and second cover bodies, the first and second sound-absorbing materials may be partially provided or may be omitted.

The gap formed between the first cover body and the second cover body may be omitted. In this case, an opening may be formed at a location where cables or the like are to be drawn out.

In the disclosure, in a state where the opening and closing area is folded along the pair of first slits toward a terminal side of the first slit, when the opening locking portion is locked to the locked portion, the target object is partially exposed. According to this configuration, even when formed of an elastomer, the covered state of the target object may be suitably maintained with a simple structure. Thus, a highly reliable cover may be provided.

On the other hand, by locking the opening locking portion to the locked portion in a state where the opening and closing area is folded, the open state may be maintained without the worker having to hold the opening and closing area by hand, allowing the target object to be exposed while the cover is attached. Thus, inspection work of necessary locations may be performed with good workability while maintaining the covered state.

In another aspect of the disclosure, the opening locking portion is an opening locking piece, and the locked portion is a hole through which the opening locking piece may be inserted.

According to this aspect, with a simple structure of inserting and locking the opening locking piece to the hole, the open state of the opening and closing area may be maintained.

In another aspect of the disclosure, the opening locking piece includes a groove formed between the opening locking piece and the opening and closing area, and when the opening locking piece is inserted into the hole, the groove is locked to the edge portion of the hole.

According to this aspect, the locked state between the opening locking piece and the hole is effectively maintained, making it less likely for the opening and closing area in the open state to unexpectedly return to the closed state.

In another aspect of the disclosure, the opening locking piece is provided on the stepped portion of the opening and closing area.

According to this aspect, by utilizing the stepped portion, the opening locking piece may be provided at a position where it may be easily locked to the hole.

In another aspect of the disclosure, the hole is formed in a size that allows the stepped portion to be inserted in a folded state of the opening and closing area.

According to this aspect, even if the stepped portion is formed on the opening and closing area, the opening and closing area may be folded along the surface of the first cover body, making it less likely for the opening and closing area to interfere with work in the open state.

In another aspect of the disclosure, a pair of first slits are formed sandwiching the first locking portion, making the first locking portion, which is integral with the opening and closing area, also serves as the opening locking portion. Furthermore, the locked portion is configured as a locking hole into which the first locking portion may be inserted and locked in the state where the opening and closing area is folded.

According to this aspect, a rational configuration is achieved by making the first locking portion also serves as the opening locking portion.

In another aspect of the disclosure, a pair of second slits are formed in the first sound-absorbing material configured on the inner surface of the first cover body, and when the inner side opening and closing area sandwiched between the pair of second slits is folded together with the opening and closing area toward the terminal side of the second slits, the target object may be partially exposed.

Moreover, in the covered state of the target object by the opening and closing area, the second slits are covered by the opening and closing area.

According to this aspect, even with the first sound-absorbing material provided on the inner side of the first cover body, the target object may be exposed by opening the inner side opening and closing area. Further, in the closed state, the second slits are covered by the opening and closing area, so even with the second slits provided in the first sound-absorbing material, the covered state of the target object may be maintained, preventing the intrusion of foreign objects from the outside. In another aspect of the disclosure, the inner side opening and closing area is fixed to the opening and closing area.

According to this aspect, the inner side opening and closing area automatically follows the opening and closing action of the opening and closing area, and the opening and closing action of the opening and closing area may be performed without hindrance even with the presence of the inner side opening and closing area.

What is claimed is:

1. A cover, the cover comprising:
a first cover body formed of an elastomer and integrally having a first locking portion at a first end edge; and
a second cover body formed of an elastomer and integrally having a second locking portion at a second end edge opposing the first end edge, the second locking portion being capable of locking to the first locking portion,
wherein in a state where the first end edge and the second end edge are joined, by locking the first locking portion and the second locking portion to each other, a target object is covered by the first cover body and the second cover body,
the first cover body comprises:
a pair of first slits extending in a direction intersecting the first end edge, starting from the first end edge;
an opening locking portion integrally formed in an opening and closing area sandwiched between the pair of first slits; and
a locked portion provided on a terminal side of the first slit, and
in a state where the opening and closing area is folded along the pair of first slits toward a terminal side of the first slit, when the opening locking portion is locked to the locked portion, the target object is partially exposed.

2. The cover according to claim 1, wherein the opening locking portion is an opening locking piece protruding in a direction opposite to an abutting direction from the first end edge to the second end edge, and
the locked portion is a hole in which the opening locking piece is locked.

3. The cover according to claim 2, wherein the opening locking piece has a groove formed between the opening locking piece and the opening and closing area,
the hole is provided on an extension surface of the opening and closing area in a covered state of the target object by the opening and closing area, and
when the opening locking piece is inserted through the hole, the groove is locked to an edge portion of the hole.

4. The cover according to claim 3, wherein the opening and closing area has a stepped portion protruding on a surface side of the first cover body, and
the opening locking piece is provided on the stepped portion.

5. The cover according to claim 4, wherein the hole is formed in a size that allows the stepped portion to be inserted in a folded state of the opening and closing area.

6. The cover according to claim 1, wherein the pair of first slits are formed sandwiching the first locking portion, and the first locking portion, which is integral with the opening and closing area, also serves as the opening locking portion, and
the locked portion is a locking hole into which the first locking portion is inserted and locked in a state where the opening and closing area is folded towards a terminal side of the first slit.

7. The cover according to claim 1, wherein a first sound-absorbing material formed of foam resin is configured on an inner surface of the first cover body, and
in the first sound-absorbing material, a pair of second slits extending in a direction intersecting with the first end edge are formed on an inner side of the opening and closing area, starting from an inner side end edge positioned on the first end edge side, and an inner side opening and closing area of the first sound-absorbing material sandwiched between the pair of second slits is folded along the pair of second slits toward a terminal side of the second slit together with the opening and closing area to partially expose the target object, while
in a covered state of the target object by the opening and closing area, the pair of second slits are covered by the opening and closing area.

8. The cover according to claim 7, wherein the inner side opening and closing area is fixed to the opening and closing area.
